(19) United States
(12) Patent Application Publication
(10) Pub. No.: US 2007/0037927 A1
(43) Pub. Date: Feb. 15, 2007

(54) Compatibilized blends of ABS copolymer and polyolefin

(75) Inventor: Huan Yang, Katy, TX (US)

Correspondence Address: KRATON POLYMERS U.S. LLC, WESTHOLLOW TECHNOLOGY CENTER, 3333 HIGHWAY 6 SOUTH, HOUSTON, TX, 77082, US

(73) Assignee: KRATON Polymers U.S. LLC, Houston, TX (US)

(21) Appl. No.: 11/202,594

(22) Filed: Aug. 12, 2005

(51) Int. Cl. C08L 53/00

(52) U.S. Cl. 525/88

(57) ABSTRACT

The present invention is directed to blends of ABS copolymer and aliphatic polymers, such as polyolefins, which blends include a compatibilizer. Such blends exhibit improved impact resistance over blends lacking the compatibilizer.

### FIELD OF THE INVENTION

The present invention is directed to blends of an acrylonitrile-butadiene-styrene (ABS) copolymer and an aliphatic polymer, such as a polyolefin, which blends also include a compatibilizer. The blends of the present invention exhibit improvements over blends lacking the compatibilizer.

### BACKGROUND OF THE INVENTION

ABS is a copolymer exhibiting a relatively effective degree of toughness and dimensional stability. ABS is comprised of styrene, acrylonitrile and butadiene monomer units. The polybutadiene elastomeric component of ABS exists as a discrete phase dispersed in the thermoplastic components i.e., a copolymer of styrene and acrylonitrile. The nitrile groups from neighboring chains attract each other, due to their polarity, which binds the chains together. The presence of styrene gives the material a shiny, impervious surface. Butadiene, owing to its elastic properties, provides ABS with resilience.

Polypropylene (PP) and polyethylene (PE) are well-known versatile thermoplastic materials available in many grades to meet the needs of various production methods such as extrusion, injection molding, thermoforming, and blow molding, to name but a few applications. Polypropylene and polyethylene are among the most non-polar thermoplastic polymers.

Because ABS copolymers may exhibit less than desirable environmental stability, due to relatively inadequate solvent resistance, an overcoat is often applied to articles constructed of ABS. Potentially, this disadvantage might also be addressed via blending ABS with a material exhibiting a better weatherability and/or solvent resistance than ABS.

PP and PE are materials that, in a blend with an ABS copolymer, could improve the properties of neat ABS. However, blends of ABS and PP and blends of ABS and PE exhibit poor compatibility due to their extreme differences in polarity, which adversely affects the physical properties exhibited by blends of same and leads to sub optimal impact performance. Aliphatic polymers such as PP and PE are generally non-polar, while in contrast the ABS copolymer exhibits polarity. The lack of compatibility between these materials results in blends that, on the whole, would be considered marginally usable or non-usable by the skilled artisan.

### SUMMARY OF THE INVENTION

The present invention is directed to a compatibilized blend of an ABS-type copolymer and an aliphatic polymer, which blend is comprised of (a) an aliphatic polymer; (b) an ABS copolymer; and (c) a compatibilizer.

In one aspect, the aliphatic polymer may be a polyolefin such as polyethylene, polypropylene and polybutylene, among others. Propylene polymers include, for example, polypropylene homopolymers, propylene copolymers with one or more alpha olefins, high impact polypropylene, branched polypropylene, and polypropylenes made using single site and metallocene catalysts. Polyethylene polymers includes high density polyethylene (HDPE), low density polyethylene (LDPE), linear low density polyethylene (LLDPE), ultra or very low density polyethylene (ULDPE or VLDPE), medium density polyethylene (MDPE), etc. In one specific aspect, the present invention provides a compatibilized composition comprising ABS copolymer, polypropylene and a compatibilizing block copolymer.

In another aspect of the present invention, the compatibilizer is a fuctionalized, selectively hydrogenated block copolymer selected from the group consisting of AB diblock copolymers and multiblock copolymers having at least two end blocks A and at least one mid block B to which has been grafted an acid compound or its derivative wherein,
(1) each A is predominantly a polymerized monoalkenyl aromatic hydrocarbon block having an average molecular weight of about 2,000 to 115,000;
(2) each B is predominantly a polymerized conjugated diene hydrocarbon block having an average molecular weight of about 20,000 to 450,000;
(3) the blocks A constituting 5-95 weight percent of the copolymer,
(4) the unsaturation of the block B is reduced to less than 10% of the original unsaturation;
(5) the unsaturation of the A blocks is above 50% of the original unsaturation; and
(6) substantially all of the acid compounds or their derivatives are grafted to the block copolymer at secondary or tertiary carbon positions.

Suitable compatibilizers include a selectively hydrogenated SEBS (styrene ethylene/butylene styrene) block copolymer to which an acid component or acid derivative has been grafted. Such block copolymers with a grafted acid component or derivative thereof and methods of making the same are disclosed in U.S. Pat. No. 4,578,429, incorporated herein by reference.

The grafted compounds may be derived from any ethylenically unsaturated monomer(s) having the ability to react with the base polymer in free radical initiated reactions. Preferred among such monomers are those which are non-polymerizable or which polymerize at relatively slow rates. Such monomers include unsaturated mono- and polycarboxylic-containing acids (C₃-C₁₀) with preferably at least one olefinic unsaturation, and anhydrides, salts, esters, ethers, amides, nitriles, thiols, thioacids, glycidyl, cyano, hydroxy, glycol, and other substituted derivatives from said acids.

Examples of such acids, anhydrides and derivatives thereof include maleic acid, fumaric acid, itaconic acid, citraconic acid, acrylic acid, glycidyl acrylate, cyanoacrylate, hydroxy C₁-C₂₀ alkyl methacrylates, acrylic polyethers, acrylic anhydride, methacrylic acid, crotonic acid, isocrotonic acid, mesaconic acid, angelic acid, maleic anhydride, itaconic anhydride, citraconic, anhydride, acrylonitrile, methacrylonitrile, sodium acrylate, calcium acrylate, and magnesium acrylate.

A preferred compatibilizer is a maleated selectively hydrogenated SEBS copolymer, that is, a selectively hydrogenated SEBS copolymer to which maleic anhydride has been grafted.

The applicant has found that ABS/aliphatic polymer blends can be impact modified by the use of compatibilizers, which blends show significant improvements with respect to certain physical properties, when compared to blends not including a compatibilizer. With the addition of a compatibilizer, the components appear more receptive to blending, at least as evidenced by the results of notched Izod and instrumented impact testing. That is, blends including a compatibilizer exhibit a significant improvement in impact resistance over blends not including a compatibilizer. Generally, adding compatibilizers might result in finer dispersions, as well as more regular and stable morphologies, and increased mechanical performance and surface properties.

The compatibilized blends of the present invention exhibit excellent impact resistance and rigidity, as well as improved environmental stability and weatherability. It is contemplated that the blends of the present invention can be used to form articles such as housings for visual display devices (i.e., television, computer monitors), computers, household items, automotive parts, to name but a few of many examples. In addition, these blends should be amenable to recycling operations in which polar and nonpolar polymers are commingled and co-processed. As such this invention provides blends with useful physical, chemical and stability properties heretofore unavailable.

### DETAILED DESCRIPTION OF THE INVENTION

The ABS copolymer may comprise 5-60 wt % of a polybutadiene rubber, 5-50 wt % of an acrylonitrile, and 25-85 wt % of a styrene monomer. The formation of ABS copolymers is documented and described in, at least, U.S. Pat. Nos. 3,442,979, 3,442,980, 3,442,981, 3,444,271 and 3,448,175, all of which are incorporated herein by reference. Preferred proportions of each monomer are indicated below:

| | % by weight |
|---|---|
| Polybutadiene | 10-55 |
| Acrylonitrile | 7.5-35 |
| Styrene | 30-70 |

The aliphatic polymers employed in the blends of the present invention generally are semi-crystalline or crystallizable olefin polymers including homopolymers, copolymers, terpolymers, or mixtures thereof, etc., containing one or more monomeric units. Polymers of alpha-olefins or 1-olefins may be derived from olefins such as ethylene, propylene, 1-butene, 1-pentene, 4-methyl-1-pentene, 1-octene, 1-decene, 4-ethyl-1-hexene, etc., or mixtures of two or more of these olefins. Examples of particularly useful olefin polymers include low-density polyethylene, high-density polyethylene, linear low density polyethylene, ultra low density polyethylene, polypropylene (including isotactic polypropylene), (high and low density) poly(1-butene), poly(4-methyl-1-pentene), ultra low molecular weight polyethylene, ethylene-based ionomers, poly(4-methyl-1-pentene), ethylene-propylene copolymers, copolymers of olefin-diene copolymers, ethylene-propylene-diene copolymers (EPDM), copolymers of ethylene and/or propylene with other copolymerizable monomers such as ethylene-1-butylene copolymer, ethylene-vinyl acrylate copolymer, ethylene-ethyl acetate copolymer, propylene-4-methyl-1-pentene copolymer, ethylene-vinyl acetate, ethylene vinyl alcohol, ethylene acrylic elastomer such as ethylene-methyl acrylate-acrylic acid terpolymers, etc. Halogenated olefins, polymers and copolymers may also be used herein.

The aliphatic polymer to be included in the blend can be any aliphatic polymer, such as a polyolefin, which polymer may be a homopolymer or optionally, a copolymer. For example, the aliphatic polymer may be a polypropylene homopolymer or a copolymer of a polyolefin, such as high impact polypropylene with ethylene propylene rubber as the disperse phase.

The compatibilizer, as described above, includes an acid component or derivative thereof grafted to the aforedescribed block copolymer. However, a portion of compatibilizer comprising the aforedescribed block copolymer not having an acid compound or derivative thereof grafted thereto may be included in the blend as well, while still attaining the improvement in physical properties of the blend.

Selectively hydrogenated block copolymers that can be used as the compatibilizer include block copolymers of conjugated dienes and vinyl aromatic hydrocarbons which exhibit elastomeric properties and which have 1,2-microstructure contents prior to hydrogenation of from about 7% to about 100%. Such block copolymers may be multiblock copolymers of varying structures containing various ratios of conjugated dienes to vinyl aromatic hydrocarbons including those containing up to about 60 percent by weight of vinyl aromatic hydrocarbon. Thus, multiblock copolymers may be utilized which are linear or radial, symmetric, or asymmetric and which have structures represented by the formulae, A-B, A-B-A, A-B-A-B, B-A, B-A-B, B-A-B-A, (AB)_{0,1,2} . . . BA and the like wherein A is a polymer block of a vinyl aromatic hydrocarbon or a conjugated diene/vinyl aromatic hydrocarbon tapered copolymer block and B is a polymer block of a conjugated diene.

The block copolymers may be produced by any well known block polymerization or copolymerization procedures including the well known sequential addition of monomer techniques, incremental addition of monomer techniques or coupling techniques as illustrated in, for example, U.S. Pat. Nos. 3,251,905, 3,390,207, 3,598,887, and 4,219,627, all of which are incorporated herein by reference. As is well known in the block copolymer art, tapered copolymer blocks can be incorporated in the multiblock copolymer by copolymerizing a mixture of conjugated diene and vinyl aromatic hydrocarbon monomers utilizing the difference in their copolymerization reactivity rates. Various patents describe the preparation of multiblock copolymers containing tapered copolymer blocks including U.S. Pat. Nos. 3,251,905, 3,265,765, 3,639,521, and 4,208,356, the disclosures of which are incorporated herein by reference.

Conjugated dienes which may be utilized to prepare the polymers and copolymers are those having from 4 to 8 carbon atoms and include 1,3-butadiene, 2-methyl-1,3-butadiene(isoprene), 2,3-dimethyl-1,3-butadiene, 1,3-pentadiene, 1,3-hexadiene, and the like. Mixtures of such conjugated dienes may also be used. The preferred conjugated diene is 1,3-butadiene.

Vinyl aromatic hydrocarbons which may be utilized to prepare copolymers include styrene, o-methylstyrene, p-methylstyrene, p-tert-butylstyrene, 1,3-dimethylstyrene, alpha-methylstyrene, vinylnaphthalene, vinylanthracene and the like. The preferred vinyl aromatic hydrocarbon is styrene.

Grafted Compounds

In general, any materials having the ability to react with the base polymer, in free radical initiated reactions are operable for the purposes of the invention.

In order to incorporate functional groups into the base polymer, monomers capable of reacting with the base polymer, for example, in solution or in the melt by a free radical mechanism are necessary. Monomers may be polymerizable or nonpolymerizable, however, preferred monomers are nonpolymerizable or slowly polymerizing.

The monomers must be ethylenically unsaturated in order to take part in free radical reactions. The grafting of unsaturated monomers has a slow polymerization rate. The resulting graft copolymers contain little or no homopolymer of the unsaturated monomer and contain only short grafted monomer chains, which do not separate into separate domains.

The class of preferred monomers which will form graft polymers within the scope of the present invention have one or more functional groups or their derivatives such as carboxylic acid groups and their salts, anhydrides, esters, imide groups, amide groups, acid chlorides and the like in addition to at least one point of unsaturation.

These functionalities can be subsequently reacted with other modifying materials to produce new functional groups. For example a graft of an acid-containing monomer could be suitably modified by esterifying the resulting acid groups in the graft with appropriate reaction with hydroxy-containing compounds of varying carbon atoms lengths. The reaction could take place simultaneously with the grafting or in a subsequent post modification reaction.

The grafted polymer will usually contain from 0.02 to 20, preferably 0.1 to 10, more preferably 0.2 to 5, and most preferably 1 to 4 weight percent of grafted portion.

The preferred modifying monomers are unsaturated mono- and polycarboxylic-containing acids (C₃-C₁₀) with preferably at least one olefinic unsaturation, and anhydrides, salts, esters, ethers, amides, nitrites, thiols, thioacids, glycidyl, cyano, hydroxy, glycol, and other substituted derivatives from said acids.

Examples of such acids, anhydrides and derivatives thereof include maleic acid, fumaric acid, itaconic acid, citraconic acid, acrylic acid, glycidyl acrylate, cyanoacrylates, hydroxy C₁-C₂₀ alkyl methacrylates, acrylic polyethers, acrylic anhydride, methacrylic acid, crotonic acid, isocrotonic acid, mesaconic acid, angelic acid, maleic anhydride, itaconic anhydride, citraconic anhydride, acrylonitrile, methacrylonitrile, sodium acrylate, calcium acrylate, and magnesium acrylate.

Other monomers which can be used either by themselves or in combination with one or more of the carboxylic acids or derivatives thereof include C₂-C₅₀ vinyl monomers such as acrylamide, acrylonitrile and monovinyl aromatic compounds, i.e. styrene, chlorostyrenes, bromostyrenes, α-methyl styrene, vinyl pyridines and the like.

Other monomers which can be used are C₄ to C₅₀ vinyl esters, vinyl ethers and allyl esters, such as vinyl butyrate, vinyl laurate, vinyl stearate, vinyl adipate and the like, and monomers having two or more vinyl groups, such as divinyl benzene, ethylene dimethacrylate, triallyl phosphite, dialkylcyanurate and triallyl cyanurate.

The preferred monomers to be grafted to the block copolymers according to the present invention are maleic anhydride, maleic acid, fumaric acid and their derivatives. It is well known in the art that these monomers do not polymerize easily.

Mixtures of monomer can be also added so as to achieve graft copolymers in which the graft chains at least two different monomers therein (in addition to the base polymer monomers).

The applicants have found that the proportion of compatibilizer in the blend, on a weight/weight basis of compatibilizer, is dependent upon the amount of grafted component present in the compatibilizer. The applicants have also found that one suitable compatibilizer is a product commercially available from KRATON Polymers U.S., L.L.C., Houston Tex., under the trade name FG-1901. This product is a selectively hydrogenated SEBS copolymer including 1.7 wt % grafted maleic anhydride, having 30 wt % styrene content. Another suitable product, also available from KRATON, is FG-1924, a selectively hydrogenated SEBS copolymer including 1.0 wt % grafted maleic anhydride having 13 wt. % styrene content.

On the basis of a 1.7 wt % grafted component, the compatibilizer can be present in the blend as low as about 2.0% (w/w). In the case where the compatibilizer is a blend of selectively hydrogenated functionalized SEBS copolymer and selectively hydrogenated SEBS copolymer, other selectively hydrogenated SEBS copolymers, which vary in terms of diblock content, styrene content, or other factors affecting the proportions of the constituents may be employed.

In one aspect of the invention, the ABS copolymer may be present in the polymer blend in a proportion of about 10% to about 90%, the aliphatic polymer may be present in an amount of about 10% to about 90%, and a selectively hydrogenated SEBS copolymer grafted with maleic anhydride (compatibilizer) may be present in a proportion of about 2% to about 20% all on a weight/weight basis. In another aspect of the invention, the maleic anhydride is present in the compatibilizer in a proportion of about 1% to about 4% (w/w).

A suitable commercial aliphatic polymer product is available from BP Amoco Polymers, Inc., under the trade name of ACCTUF 3143, which is a high impact resistant polypropylene copolymer.

Yet another suitable polymer is FORTIFLEX® G60-25-144, a high density polyethylene homopolymer typically used in the production of sheet extrusion and blow molded containers. It has a melt flow index of 0.25 g/10 min at 190° C./2160 g. FORTIFLEX® G60-25-144 is available form BP Solvay, Houston Tex.

A suitable ABS copolymer is a high impact extrusion grade, for example an ABS copolymer commercially available from Bayer Plastics Division of the Bayer Corporation under the trade name LUSTRAN® ABS 752.

The blended polymer compositions of the present invention including the aliphatic polymer, ABS-type copolymer, and the compatibilizer can be prepared by, for example, intimately mixing the polymers in a melt using conventional mixing equipment such as a mill, a Banbury mixer, a Brabender Torque Rheometer, a single or twin screw extruder, continuous mixers, and kneaders. The polymers may be intimately mixed in the form of granules and/or a powder in a high shear mixer. One preferred process for preparing the blended polymers utilizes the Farrel Continuous Mixer (FCM CP-23). Short residence times and high shear are readily obtained in a CP-23. “Intimate” mixing means that the mixture is prepared with sufficient mechanical shear and thermal energy to produce a dispersed phase, which is finely divided and homogeneously dispersed in the continuous or principal phase. The blended polymer compositions of the present invention may be prepared by melt-blending the aforementioned components. The polymer blends of the present invention are characterized as having improved impact strengths.

Polymer blends of the present invention can be used to manufacture articles where improved toughness is desired. Such articles include automotive parts, such as consoles, door panels, exterior grilles, and lift gates; housewares, such as appliance housings, and other articles such as personal care devices, medical care devices, business machines, computer housings, electronic devices, telecommunication devices, telephones, toys, tools, building materials and other construction products, to name but a few possible examples.

### EXAMPLES

Test samples produced from blends of the present invention, and test samples produced from blends formulated for comparative purposes were prepared from the following materials. All proportions expressed herein are on a weight/weight basis.

LUSTRAN ABS 752 resin—a high impact extrusion grade of ABS;

ACCTUF 3143—a high impact copolymer polypropylene;

FORTIFLEX® G60-25-144, a high density polyethylene homopolymer, as described above;

FG1901: 1.7 wt % grafted maleic anhydride selectively hydrogenated SEBS copolymer, 30 wt. % styrene content, available from KRATON Polymers U.S., L.L.C., Houston Tex.;

G1657: selectively hydrogenated SEBS copolymer with 30% Diblock, 13% styrene content, available from KRATON Polymers U.S., L.L.C., Houston Tex.;

MD6939M: selectively hydrogenated SEBS copolymer, 18% styrene content, available from KRATON Polymers;

G1701: SEB diblock copolymer, 37% styrene content, available from KRATON Polymers.

Epolene G-3003, a maleic anhydride-grafted polypropylene, is commercially available from Eastman. It has a melt flow of 12.7 at 190° C.

Samples were prepared by blending the components in the proportions specified in examples 1-17 (and CE 1), which components were initially pre-compounded in a Berstorff 25-mm diameter co-rotating twin screw extruder. The extruder zone temperature ranges between 215° C. to 240° C. The extruder screw speed is 300 rpm. Injection molded test specimens were made from pelletized extrudate using a reciprocating screw injection molder (Engel 250). The injection molding zone temperature ranges between 216° C. and 241° C., the mold temperature is set at 24° C., the injection pressure is 1050 psi. A family mold was used to make the notched Izod and tensile bars. Prior to the extrusion and injection molding steps, the blended components were dried at 80° C. for more than four hours.

The toughness of the blends was determined by the notched Izod impact test in accordance with ASTM D-256. Samples were injection molded as plaques (0.125 inch thick). Ten samples were tested, and the averages were reported as the final result.

The tensile testing was conducted on dogbone tensile bars according to ASTM 638 using Instron 5567. The dogbone width was 0.5 inch, and the thickness was 0.125 inch. The gauge length was 2.5 inch, and grip separation was 4.5 inch. The crosshead speed was set at 2 in/min. Five samples were tested, and the average was reported as the final result.

All samples tested in this example were conditioned at 23° C. and 50% relative humidity for at least 24 hours.

TABLE 1
ABS Copolymer Impact Modification

| | #1 | #2 | #3 | #4 | #5 | #6 | #7 | #8 | #9 | #10 |
|---|---|---|---|---|---|---|---|---|---|---|
| ABS752 | 100 | 80 | 80 | 80 | 90 | 80 | 80 | 80 | 90 | 95 |
| FG1901 | | 20 | | 10 | 5 | 10 | | 10 | 2.5 | 2.5 |
| G1657 | | | 20 | 10 | 5 | | | | 7.5 | 2.5 |
| G1652 | | | | | | 10 | | | | |
| MD6939M | | | | | | | 20 | 10 | | |
| Notched Izod (ft-lb/inch) | 9.4 | 11.4 | 2.0 | 11.8 | 12.0 | 12.4 | 2.8 | 12.2 | 11.8 | 11.6 |
| Tensile yield stress (psi) | 5366 | 3359 | 3202 | 3371 | 4401 | 3699 | 3390 | 3391 | 4597 | 5296 |
| Tensile break stress (psi) | 4086 | 3112 | 2914 | 2927 | 3446 | 3175 | 3036 | 2832 | 3266 | 3706 |
| Tensile Elongation (%) | 24 | 73 | 11 | 39 | 50 | 73 | 23 | 58 | 47 | 24 |

TABLE 2
ABS and PP or PE Blends, With and Without Compatibilizer

| | #11 | #12 | #13 | #14 | #15 | #16 | #17 | CE1 |
|---|---|---|---|---|---|---|---|---|
| ABS752 | 50 | 45 | 45 | 47.5 | 47.5 | 50 | 45 | 45 |
| FG1901 | | | 10 | 2.5 | | | 10 | |
| G1657 | | 10 | | 2.5 | | | | |
| ICP (ACCTUF 3143) | 50 | 45 | 45 | 47.5 | 47.5 | | | 45 |
| G1701 | | | | | 5 | | | |
| HDPE (FORTIFLEX ® G60-25-144) | | | | | | 50 | 45 | |
| Maleic grafted PP (G-3003) | | | | | | | | 10 |
| Notched Izod (ft-lb/inch) | 1.2 | 2.4 | 4.7 | 2.3 | 1.5 | 1 | 2.1 | 1.0 |
| Instrumented Impact (in-lb) | 11 | 26 | 59 | 30 | 25 | 24 | 45 | 8 |
| Tensile yield stress (psi) | 3554 | 3139 | 3398 | 3705 | 3366 | 4007 | 3712 | 4122 |
| Tensile break stress (psi) | 3439 | 2590 | 2887 | 3244 | 3221 | 4007 | 2866 | 3885 |
| Tensile Elongation (%) | 3 | 37 | 75 | 13 | 3 | 2 | 53 | 27 |

Notched Izod Impact Properties

Neat ABS 752 had a notched Izod impact of 9.4 ft-lb/inch (as shown in example 1). Adding selectively hydrogenated SEBS copolymer (ungrafted) (G1657) to ABS reduced the impact of blends. As shown in example 3 and 7, a blend of 80% ABS752 and 20% G1657 had a notched Izod impact resistance of 2.0 ft-lb/inch, and a blend of 80% ABS752 and 20% MD6939M had a notched Izod impact resistance of 2.8 ft-lb/inch, lower than the impact of neat ABS.

Impact resistance of the blend improved significantly with incorporation of FG 1901, a selectively hydrogenated SEBS copolymer grafted with maleic anhydride. The selectively hydrogenated SEBS copolymer grafted with maleic anhydride were added to ABS either alone or in conjunction with the selectively hydrogenated SEBS copolymer (ungrafted), and in the case of the latter, notched Izod impact resistance of the blend was also improved. As shown in example 2, (20% FG1901+80% ABS752), the notched Izod impact resistance of the blend increased to 11.4 ft-lb/inch. In examples 4-6 and 8-10, incorporating the selectively hydrogenated SEBS copolymer grafted with maleic anhydride and the selectively hydrogenated SEBS copolymer (ungrafted) into ABS improved the notched Izod impact resistance of such blends. Even at low concentration of the selectively hydrogenated SEBS copolymer grafted with maleic anhydride (FG 1901), there was still an improvement in impact resistance. For instance, in example 10, with only 2.5% selectively hydrogenated SEBS copolymer grafted with maleic anhydride and 2.5% selectively hydrogenated SEBS copolymer (ungrafted), the notched Izod impact was 11.6 ft-lb/inch. The ratio between selectively hydrogenated SEBS copolymer (grafted) and the selectively hydrogenated SEBS copolymer (ungrafted) varied from 1:1 to 1:3. See examples 5 and 9.

Tensile Properties

Adding the selectively hydrogenated SEBS copolymer (grafted) alone or in combination with the selectively hydrogenated SEBS copolymer (ungrafted) increased the tensile elongation significantly, providing greater ductility in the blend. Example 1 demonstrated that with neat ABS, the tensile elongation was 24%. With incorporation of 20% selectively hydrogenated SEBS copolymer (grafted) into the blend, elongation increased to 73% (example 2). Tensile elongation was improved where the blend incorporated both selectively hydrogenated SEBS copolymer (grafted) and selectively hydrogenated SEBS copolymer (ungrafted). See examples 4-6,8-10.

Examples 11-17 are directed to blends of ABS and PP or PE with and without a compatibilizer. Example 11, a 50/50 ABS/PP blend without a compatibilizer, exhibited a notched Izod impact resistance of 1.2 ft-lb/inch. With addition of 10% selectively hydrogenated SEBS copolymer (ungrafted) (G1657) in example 12, the notched Izod impact resistance was doubled relative to example 11. With the addition of 10% selectively hydrogenated SEBS copolymer (grafted) (FG1901) in example 13, the notched Izod impact resistance was approximately four times greater when compared to the ABS/PP blend without a compatibilizer (4.7 ft-lb/inch vs. 1.2 ft-lb/inch). Incorporating both the selectively hydrogenated SEBS copolymer (grafted) and the selectively hydrogenated SEBS copolymer (ungrafted) also improved notched Izod impact resistance, as shown in example 14.

A blend identified as CE1 was prepared for comparison with the blends of the present invention. CE1 is an ABS/PP blend including 10% maleic anhydride-grafted PP as a compatibilizer. As reported in Table 2, CE1 exhibited a notched Izod impact of 1.0 ft-lb/in, lower than the neat ABS/PP blend, and considerably lower than the blend with 10% maleic anhydride-grafted SEBS (1.0 ft-lb/in vs. 4.7 ft-lb/in). Therefore, maleic anhydride-grafted PP is not as good a compatibilizer as maleic anhydride grafted SEBS block copolymer.

Blends of ABS/HDPE are represented in examples 16 and 17, which respectively omit and include compatibilizer (FG1901) in the blends. Comparing examples 16 and 17, it is seen that notched Izod impact resistance was improved by over 100% when 10% FG1901 was included.

Instrumented Impact

The test pieces of examples 11-17 were subjected to instrumented impact testing which was conducted on Dynatup 8250 according to ASTM D3763. Samples were injection molded plaques at 0.125 inch thick. The impact velocity was approximately 9150 in/min.

The instrumented impact testing results showed that when compatibilizer of maleic anhydride-grafted SEBS is included in the blends of ABS/PP and ABS/HDPE, the instrumented impact of the blend was improved significantly.

As shown in sample 13 and CE1, with 10% compatibilizer, the instrumented impact of the ABS/PP blend with maleic anhydride-grafted SEBS is significantly higher than the blend with maleic anhydride-grafted PP (59 in-lb vs. 8 in-lb).

Tensile Properties

Incorporating the selectively hydrogenated SEBS copolymer (grafted) alone or in combination with the selectively hydrogenated SEBS copolymer (ungrafted) to ABS/PP blends increased tensile elongation significantly, evidencing improvement in ductility. For 50% ABS/50% PP, tensile elongation was 3% (example 11). With incorporation of 10% selectively hydrogenated SEBS copolymer (ungrafted) (G1657), the blend exhibited tensile elongation of 37% (example 12). With incorporation of 10% selectively hydrogenated SEBS copolymer (grafted) FG1901, the blend had a tensile elongation of 75% (example 13). Incorporating 2.5% selectively hydrogenated SEBS copolymer (grafted) and 2.5% selectively hydrogenated SEBS copolymer (ungrafted) into an ABS/PP blend still exhibited a tensile elongation of 13% (example 14), greater than the neat ABS/PP blends. As shown in sample 13 and CE1, with 10% compatibilizer, the tensile elongation of the ABS/PP blend with maleic anhydride-grafted SEBS is significantly higher than the blend with maleic anhydride-grafted PP (75% vs. 27%).

Incorporating the selectively hydrogenated SEBS copolymer (grafted) alone to ABS/HDPE blends also increased tensile elongation significantly, indicating improvement in ductility. For 50% ABS/50% HDPE, tensile elongation was 2% (example 16). With incorporation of 10% selectively hydrogenated SEBS copolymer (grafted) (FG1901), the blend exhibited tensile elongation of 53% (Example 17), much greater than neat ABS/HDPE blend.

What is claimed:

1. A polymer blend comprising an ABS copolymer component, an aliphatic polymer component, and a compatibilizer wherein the compatibilizer is a selectively hydrogenated block copolymer selected from the group consisting of AB diblock copolymers and multiblock copolymers having at least two end blocks A and at least one mid block B to which block copolymer an acid compound or its derivative has been grafted, wherein each A block is predominantly a polymerized monoalkenyl aromatic hydrocarbon block, the B block is predominantly a polymerized conjugated diene hydrocarbon block; and wherein the compatibilizer is present in an amount effective to compatibilize the ABS copolymer component and the aliphatic polymer component.

2. The polymer blend of claim 1 wherein each A has an average molecular weight of about 2,000 to 115,000; each B has an average molecular weight of about 20,000 to 450,000; the blocks A constituting 5-95 weight percent of the copolymer; the unsaturation of the block B is reduced to less than 10% of the original unsaturation; the unsaturation of the A blocks is above 50% of the original unsaturation; and substantially all of the acid compounds or their derivatives are grafted to the block copolymer at secondary or tertiary carbon positions.

3. The polymer blend of claim 1 wherein the aliphatic polymer is selected from the group consisting of polyethylene, polypropylene, and polybutylene.

4. The polymer blend of claim 1 wherein the aliphatic polymer is selected from the group consisting of polypropylene homopolymers, propylene copolymers including at least one alpha olefin monomer, high impact polypropylene, branched polypropylene, and polypropylenes made using single site and metallocene catalysts, high density polyethylene (HDPE), low density polyethylene (LDPE), linear low density polyethylene (LLDPE), ultra low density polyethylene (ULDPE) or very low density polyethylene (VLDPE), medium density polyethylene (MDPE).

5. The polymer blend of claim 1 wherein the aliphatic polymer is a high impact polyolefin copolymer including an ethylene propylene rubber as a disperse phase.

6. The polymer blend of claim 1 wherein the compatibilizer is a selectively hydrogenated SEBS copolymer to which said acid component or derivative thereof has been grafted.

7. The polymer blend of claim 1 wherein the compatibilizer is a selectively hydrogenated SEBS copolymer to which maleic anhydride has been grafted.

8. The polymer blend of claim 1 wherein the compatibilizer further comprises an ungrafted selectively hydrogenated SEBS copolymer.

9. The polymer blend of claim 7 wherein the compatibilizer further comprises an ungrafted selectively hydrogenated SEBS copolymer.

10. The polymer blend of claim 7 wherein the compatibilizer comprises, on a weight/weight basis, a proportion of about 0.2% to about 5% maleic anhydride.

11. The polymer blend of claim 1 wherein, on a weight/weight basis, the ABS copolymer is present in a proportion of about 10% to about 90%, the aliphatic polymer is present in an amount of about 10% to about 90%, and the compatibilizer is a selectively hydrogenated SEBS copolymer grafted with maleic anhydride present in a proportion of about 2% to about 20%.

12. The polymer blend of claim 11 wherein the maleic anhydride is present in the compatibilizer in a proportion of about 0.2% to about 5%.

13. A polymer blend comprising an ABS copolymer, an aliphatic polymer selected from the group consisting of polyethylene and polypropylene, and a selectively hydrogenated SEBS copolymer grafted with maleic anhydride in an amount effective to compatibilize the ABS copolymer and the aliphatic polymer.

14. The polymer blend of claim 13 wherein the selectively hydrogenated SEBS copolymer grafted with maleic anhydride is present in a proportion of about 2% to about 20%, on a weight/weight basis.

15. The polymer blend of claim 13 wherein, on a weight/weight basis, the ABS copolymer is present in a proportion of about 10% to about 90%, the aliphatic polymer is present in an amount of about 10% to about 90%, and the selectively hydrogenated SEBS copolymer grafted with maleic anhydride is present in a proportion of about 2% to about 20%.

16. The polymer blend of claim 13 wherein the maleic anhydride is present in the compatibilizer in a proportion of about 0.2% to about 5%, on a weight/weight basis.

17. The polymer blend of claim 13 further comprising an ungrafted selectively hydrogenated SEBS copolymer.

18. An article comprised of the polymer blend of claim 1, wherein said article exhibits improved toughness.

19. The article of claim 18 wherein, on a weight/weight basis, the ABS copolymer is present in a proportion of about 10% to about 90%, the aliphatic polymer is present in an amount of about 10% to about 90%, and the compatibilizer is a selectively hydrogenated SEBS copolymer grafted with maleic anhydride is present in a proportion of about 2% to about 20%.

20. The article of claim 19 wherein the maleic anhydride is present in the compatibilizer in a proportion of about 0.2% to about 5%.

21. The article of claim 18 formed in a process selected from the group consisting of injection molding, over molding, extrusion, roto-molding, and blow molding.

22. The article of claim 18 wherein the article is an automotive part.

23. The automotive part of claim 22 wherein the automotive part is selected from the group consisting of a console, a door panel, an exterior grille, and a lift gate.

24. The article of claim 18 wherein the article is a houseware.

25. The houseware of claim 24 wherein the houseware is an appliance housing.

26. The article of claim 18 wherein the article is selected from the group consisting of a personal care device, a medical care device, a business machine, a computer housing, an electronic device, telecommunication device, a telephone, a building material, a construction product, a tool, and a toy.

27. A polymer blend exhibiting improved impact resistance and tensile properties, the polymer blend comprises a precompounded melt of an ABS copolymer component, an aliphatic polymer component, and a compatibilizer component, wherein the compatibilizer component is a selectively hydrogenated block copolymer selected from the group consisting of AB diblock copolymers and multiblock copolymers having at least two end blocks A and at least one mid block B to which block copolymer an acid compound or its derivative has been grafted, wherein each A block is predominantly a polymerized monoalkenyl aromatic hydrocarbon block, the B block is predominantly a polymerized conjugated diene hydrocarbon block; and wherein the compatibilizer is present in an amount effective to compatibilize the ABS copolymer component and the aliphatic polymer component.
